(19) United States
(12) Patent Application Publication
(10) Pub. No.: US 2007/0139918 A1
(43) Pub. Date: Jun. 21, 2007

(54) Indirect tasklight

(76) Inventor: Gregg Laukhuf, Bryan, OH (US)

Correspondence Address: TAYLOR & AUST, P.C., 142 SOUTH MAIN STREET, P. O. BOX 560, AVILLA, IN, 46710, US

(21) Appl. No.: 11/305,511

(22) Filed: Dec. 16, 2005

(51) Int. Cl. F21S 4/00

(52) U.S. Cl. 362/217

(57) ABSTRACT

A light assembly has a lamp, a reflector for directing incident light from the lamp downwardly, a diffuser for blocking the projection of light directly from the lamp in a downward direction, and an intervening member or bracket suspending the diffuser from the reflector. The bracket may comprise a pair of threaded shafts passing through the diffuser and a pair of nuts threadedly engaging respective shafts beneath the diffuser. The bracket may include a housing of a lighting fixture with the pair of threaded shafts passing through the diffuser and into the housing. A shelf or other superstructure from which the lamp, reflector and diffuser are suspended, is located above a work surface to be lighted. The shelf includes a support surface, a pair of generally vertically depending legs extending downwardly from the support surface, and a pair of generally horizontal ledges cantilevered from the lower extremities of the legs and extending inwardly toward one another. The reflector comprises a cylindrical segment shaped reflector curved about a cylindrical axis, having a pair of opposed outwardly extending generally parallel edges and a pair of opposed generally circular ends with each edge resting on a corresponding shelf ledge.

### BACKGROUND OF THE INVENTION

1. Field of the Invention

The present invention relates to lighting fixtures and more particularly to a fixture suitable for mounting beneath a shelf, cabinet or other overhanging structure for shedding light on an area below the overhanging structure, for example, a tasklight.

2. Description of the Related Art

Lighting fixtures are frequently mounted beneath a surface such as under kitchen cabinets, or suspended from or recessed in a ceiling. These fixtures often employ a surface mounted housing containing several electrical components such as lampholders, switches, ballasts, lamps and related wiring, and have a lens or cover removably connected to the lower portion thereof. Light is directed downwardly from the lamp through the lens or cover onto the surface below which is to be lighted. In a small office, work station or other limited space area tasklights are frequently employed to light a desktop or similar working surface. The tasklight may form a component of a more complete office environment including divider panels, shelving and similar modular furniture structures. In these installations, glare or light reflected from papers or similar items on the working surface is a frequent problem. Various combinations of reflectors, baffles perforated baffles and diffusers have been suggested to eliminate or ameliorate the glare problem. Other direct/indirect lighting fixtures having housings, arcuate reflectors, diffuser with slots, and lamps have also been suggested. None have been entirely satisfactory in that they suffer from the following drawbacks. The prior art tasklight systems are unnecessarily complex, expensive to produce, difficult to install, inadequately secure the lens or diffuser in place, or incompletely solve the glare problem.

### SUMMARY OF THE INVENTION

The present invention provides solutions to the above noted problems in the form of an improved indirect tasklight. The indirect tasklight generally includes a reflector, a perforated basket or diffuser, a light and at least one bracket securing the basket to the reflector. A tasklight supporting shelf can be part of a furniture unit, such as a modular furniture assembly, or alternatively, the shelf can be part of the indirect tasklight. The light can be a fluorescent light, an array of LEDs, an incandescent light, a combination of such lights, and/or other lights sources or combinations thereof. The light is connected to the reflector. The perforated basket or diffuser is connected to the light and/or the reflector via a bracket. The reflector is mounted by two edges resting on a pair of shelf ledges located on the lower side of the shelf.

The invention comprises, in one form thereof, a light assembly having a superstructure which overlies the surface to be lighted in the form of a longitudinally extending shelf with an upper surface for receiving materials, front and rear downwardly depending legs, and a pair of inwardly directed ledges, one near each of the lower extremities of a corresponding leg. There is a cylindrical segment shaped reflector curved about a cylindrical axis, having a pair of opposed generally circular ends and a pair of opposed generally parallel edges with each edge resting on a corresponding shelf ledge. An elongated lamp is suspended beneath the reflector and extends generally parallel to the cylinder axis for about the entire length of the reflector. The reflector directs incident light downwardly. A pair of lampholders suspended from the reflector engage and support corresponding ends of the lamp. A basket or light diffusing baffle is suspended beneath the lamp and extends substantially the entire length of the lamp to impede or limit the projection of downwardly directed light from the lamp so that an area beneath the shelf is indirectly lighted by reflected light.

An advantage of the present invention is that the number of tasklight assembly component parts is reduced.

Another advantage of the present invention is that glare on paper beneath the tasklight is reduced.

A further advantage of the present invention is a reduced likelihood of a tasklight component inadvertently loosening and falling from the tasklight assembly, and in particular, there is no risk of lens fallout because there is no lens.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is an isometric view of a tasklight assembly incorporating the invention in one form;

FIG. 2 is a cross-sectional view along line 2-2 of FIG. 1; and

FIG. 3 is a cross-sectional view along line 3-3 of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

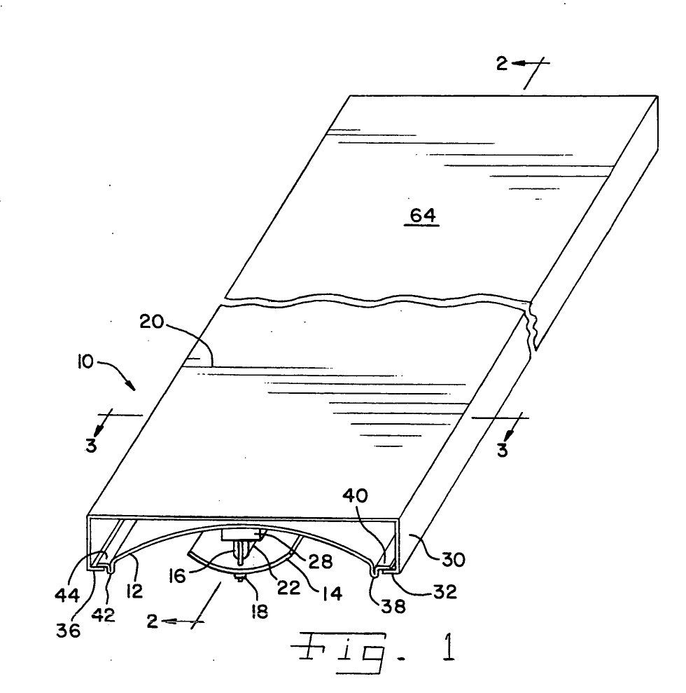

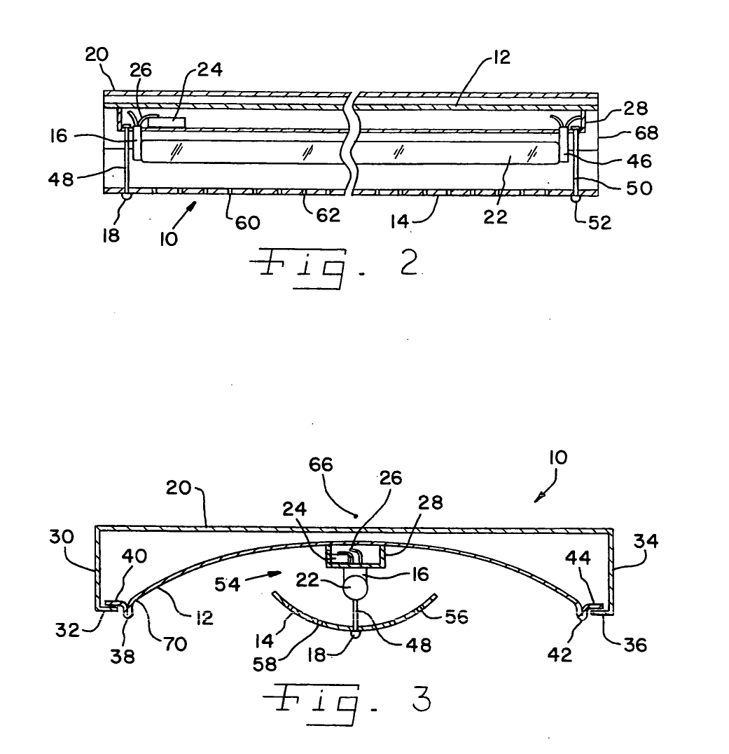

Referring now to the drawings, and more particularly to FIG. 1, there is shown a indirect tasklight assembly 10 which generally includes reflector 12, perforated basket or diffuser 14, a lighting fixture 54 (FIG. 3) including lampholders such as 16, lamp 22 and housing 28, and at least one diffuser support bracket such as nut 18 and connecting shaft 48 (FIGS. 2 and 3). Shaft 48 may screw into or be otherwise suspended from the housing 28 and/or into the reflector 12 to support the perforated basket 14. Shelf 20 can be a preexisting part of a furniture unit, such as a modular furniture assembly, or alternatively, shelf 20 can be part of indirect tasklight 10. Shelf 20 may be specially designed to accept tasklight assemblies or another shelf design may be modified to accept the assemblies. A lower portion of some other furniture item such as a cabinet or similar overhanging structure could be employed in lieu of the shelf. Shelf 20 may be sheet metal or other material. Shelf 20 is illustrated as a formed sheet metal piece having a relatively flat horizontal shelf upper support surface 64 and a pair of vertical front and rear downwardly depending legs 30 and 34. At the lower ends of the legs, the metal bends back inwardly to provide horizontal ledges 32 and 36 for supporting the reflector 12 as best seen in FIG. 3. The shelf lower portion may be open at the ends as shown in FIG. 1, enclosed by additional downwardly depending shelf legs, or otherwise blocked by adjacent furniture items. The shelf 20 and lighting fixture 54 are illustrated as nearly coextensive longitudinally, but shelf 20 may far exceed the length of the lighting fixture and may receive more than one such fixture in some applications. Similarly, lamp 22 may about coextensive with the fixture 54, or multiple lamps may be included in one fixture. The lighting fixture 54 may be a so-called strip light having a metal box 28 or other enclosure containing conventional electrical wiring 26, ballast 24 and similar components with two depending lampholders 16 and 46 for receiving there between a fluorescent tube 22 or similar lamp. The structural details of the tasklight assembly are shown in more detail in FIGS. 2 and 3.

Lamp 22 can be a fluorescent light as illustrated at 22, an array of LEDs, an incandescent light, a combination of such lamps, and/or other lights sources or combinations thereof. The light fixture 54 is connected to reflector 12 by any suitable technique. For example, upwardly extending metal tabs may pass through slots in the reflector and then be bent over or twisted to secure the lighting fixture. Metal screws or other suitable fastening procedures may be employed. The threaded shafts 48 and 50 could extend upwardly through the housing 28 to threadedly engage the reflector as well as the housing.

Perforated basket or diffuser 14 is connected to light fixture 54 and/or reflector 12 by a bracket including threaded shafts 48 and 50, and nuts 18 and 52. The diffuser is illustrated as a metal sheet formed into a segment of a right circular cylinder about an axis 66 and having numerous apertures such as 56, 58, 60 and 62. These holes or perforations may be simple drilled or punched apertures, slits, dimples formed by deforming one side of a slit out of the adjoining surface, or may be formed any other suitable technique. The basket may completely block any direct light or may function to pass and diffuse or spread some small fraction of the light incident from the lamp evenly over a desk or other work surface located beneath the tasklight. Reflected light is also directed toward the work surface. A diffuser of a mesh, or a translucent or nearly opaque material could also be used with or without perforations to fit particular lighting challenges.

Reflector 12 is illustrated as a cylindrical segment shaped reflector curved about a cylindrical axis which extends perpendicular to the plane of FIG. 3 and lies in the plane of FIG. 2. The reflector has a pair of opposed generally parallel longitudinally extending edges such as 70 as best seen in FIG. 3 and a pair of opposed generally circular ends such as 68 (FIG. 2) with each edge resting on a corresponding shelf ledge 32 or 36. The reflector edges 70 further each include a longitudinally extending bight or fold 38 or 42 having a flat flange 40 or 44 extending in a cantilevered manner laterally therefrom. Each flange 40 or 44 is intended to rest on a corresponding inwardly directed shelf ledge 32 or 36. Thus, the reflector 12 may be mounted on shelf 20 by the pair of laterally extending reflector flanges 40 and 44 which rest on a pair of ledges 32 and 36 which in turn extend horizontally inwardly from downwardly extending shelf legs 30 and 34.

Considering FIG. 2, the bracket includes lighting fixture 54 which is fixed to the reflector 12, the set of threaded shafts 48 and 50 which engage the housing 28 and pass through the basket 14 with a like set of nuts 18 and 52 each threadedly engaging a corresponding shaft beneath the basket. The diffuser 14 could be made to depend directly from the reflector 12 by extending and relocating the threaded shafts 48 and 50. A wide variety of other suitable brackets for suspending the diffuser directly from the housing or indirectly via the reflector may be employed. Housing 28 could also be eliminated and the lampholders 16 and 46 fastened directly to the reflector with the associated electrical components located elsewhere. The ballast 24 and related wiring 26 could be located on the upper side of the reflector between the reflector and the shelf lower surface. If desired, a simple housing could be employed to cover the relocated ballast and wiring.

Lamp 22 may be replaced by simply removing the two nuts 18 and 52, lowering the deflector 14, and rotating the lamp 22 about its longitudinal axis by ninety degrees in known fashion. The steps are reversed to install a new lamp. The entire tasklight assembly may be removed by first disconnecting any conventional wiring connecting the tasklight to a power source. Mechanical removal may be achieved by flexing one or both of the legs 30 and 34 outwardly so that at least one of the laterally extending reflector flanges 40 and 44 clears its corresponding ledge 32 or 36 allowing the tasklight assembly 10 to be lowered from the bottom of the shelf. Mechanical removal may also be achieved by simply sliding the tasklight longitudinally along the ledges and out of a shelf end in those installations where the shelf lower portion is open as illustrated in FIG. 1. Further, mechanical removal may be achieved by flexing the reflector upwardly to reduce the cylindrical radius of curvature drawing the laterally extending edges toward one another until at least one reflector edge clears its corresponding ledge. A combination of flexing the reflector and flexing the shelf legs could also be employed.

The bight portions 38 and 42 may be easily grasped and moved toward one another flexing the reflector to facilitate removal of the reflector from beneath the shelf, but the bights 38 and 42, and the flanges 40 and 44 may be omitted if desired and the cylindrical segment reflector edges such as 70 allowed to directly rest on the ledges. The ledges 32 and 36 need not be continuous nor coextensive with the reflector. For example inwardly directed studs or dimples formed in the metal legs could be used to support the reflector. The diffuser may be suspended by the threaded shafts from the lighting fixture housing as illustrated, suspended directly from the reflector, or suspended by any other suitable bracket arrangement.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A light assembly, comprising:
an elongated tubular lamp;
a pair of lampholders each engaging and supporting a corresponding end of the lamp;
a reflector having a pair of opposed longitudinally extending edges positioned above the lamp and extending substantially the entire length of the lamp, with the lampholders suspended from the reflector;
a light diffusing baffle suspended beneath the lamp and extending substantially the entire length of the lamp; and
a superstructure from which the reflector is suspended, including a pair of ledges, one to either lateral side of the lamp, on which opposed reflector edges rest.

2. The light assembly of claim 1, wherein the superstructure comprises a preexisting shelf.

3. The light assembly of claim 1, further comprising a lighting fixture housing supporting the lampholders and fixed to the reflector to couple the baffle and lampholders together.

4. The light assembly of claim 1, further including a bracket for coupling the baffle to the reflector.

5. The light assembly of claim 1, wherein the bracket includes a lighting fixture housing fixed to the reflector and a set of threaded shafts engaging both the housing and the baffle to suspend the baffle beneath the housing.

6. The light assembly of claim 1, wherein the superstructure comprises a shelf including a relatively flat upper receiving surface, front and a rear legs downwardly depending from the upper surface, and a pair of inwardly directed ledges near the lower extremities of respective legs for receiving the reflector edges.

7. The light assembly of claim 1, wherein the superstructure comprises a shelf having a pair of inwardly directed ledges and the reflector comprises a generally cylindrical segment terminating along a pair of transversely extending flanges, the flanges adapted to rest on corresponding ledges.

8. A light assembly, comprising:
a longitudinally extending shelf having an upper surface for receiving materials, front and rear downwardly depending legs, and a pair of inwardly directed ledges, one near each of the lower extremities of a corresponding leg;
a cylindrical segment shaped reflector curved about a cylindrical axis, having a pair of opposed generally parallel edges and a pair of opposed generally circular ends, each edge resting on a corresponding shelf ledge;
an elongated lamp suspended beneath the reflector and extending generally parallel to the cylinder axis; and
a basket suspended beneath the lamp and extending substantially the entire length of the lamp to impede downwardly directed light from the lamp, whereby an area beneath the shelf is indirectly lighted by reflected light.

9. The light assembly of claim 8, wherein the reflector edges further each include a longitudinally extending bight having a flat flange extending laterally therefrom, each flange resting on a corresponding inwardly directed ledge.

10. The light assembly of claim 8, wherein the basket includes a plurality of apertures for passing a small fraction of the incident light from the lamp.

11. The light assembly of claim 8, further including a bracket coupling the basket and reflector.

12. The light assembly of claim 11, wherein the bracket includes a lighting fixture fixed to the reflector including a housing and lampholders for supporting and energizing the lamp, a set of threaded shafts engaging the housing and passing through the basket, and a like set of nuts each threadedly engaging a corresponding shaft beneath the basket.

13. The light assembly of claim 8, wherein the basket comprises a generally cylindrical segment.

14. A light assembly having a lamp, a reflector for directing incident light from the lamp downwardly, a diffuser for limiting the projection of light directly from the lamp in a downward direction, and an intervening member suspending the diffuser from the reflector.

15. The light assembly of claim 14, wherein the intervening member comprises a pair of threaded shafts passing through the diffuser and a pair of nuts threadedly engaging respective shafts beneath the diffuser.

16. The light assembly of claim 14, wherein the intervening member comprises a housing of a lighting fixture and a pair of threaded shafts passing through the diffuser and into the housing, and a pair of nuts threadedly engaging respective shafts beneath the diffuser.

17. The light assembly of claim 14, further including a superstructure from which the lamp, reflector and diffuser are suspended.

18. The light assembly of claim 17, wherein the superstructure comprises a shelf located above a work surface to be lighted by the light assembly.

19. The light assembly of claim 18, wherein the shelf includes a support surface, a pair of generally vertically depending legs extending downwardly from the support surface, and a pair of generally horizontal ledges cantilevered from the lower extremities of the legs and extending inwardly toward one another.

20. The light assembly of claim 19, wherein the reflector comprises a cylindrical segment shaped reflector curved about a cylindrical axis, having a pair of opposed outwardly extending generally parallel edges and a pair of opposed generally circular ends, each edge resting on a corresponding shelf ledge.
